(19) United States
(12) Patent Application Publication
(10) Pub. No.: US 2010/0127949 A1
(43) Pub. Date: May 27, 2010

(54) Mobile Communication base station antenna

(75) Inventors: Takayuki Shimizu, Hitachi (JP); Shinsuke Murano, Kasama (JP); Toshiyuki Ando, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/591,596

(22) Filed: Nov. 24, 2009

(30) Foreign Application Priority Data
Nov. 26, 2008 (JP) 2008-301207

(51) Int. Cl. H01Q 21/00; H01Q 9/16

(52) U.S. Cl. 343/810; 343/844; 343/893

(57) ABSTRACT

A mobile communication base station antenna has two or more array antennas. Each of the array antennas includes a plurality of antenna element pairs arranged in array shape. Each of the antenna element pairs includes two antenna elements located to be orthogonal to each other. Polarization characteristics of the two antenna elements are orthogonal to each other. The array antennas are arranged with a predetermined distance in a vertical direction.

The present application is based on Japanese Patent Application No. 2008-301207 filed on Nov. 26, 2008, the entire contents of which are incorporated herein by reference.

### BACKGROUND OF THE INVENTION

1. Field of the Invention

The present invention relates to a dual-polarized antenna and an array antenna, more particularly, to a mobile communication base station antenna for realizing a Space Division Multiple Access (SDMA).

2. Related Art

Technique such as Frequency Division Multiple Access (FDMA), Time Division Multiple Access (TDMA), or Code Division Multiple Access (CDMA) has been proposed to realize a simultaneous connection of plural users in a base station to be used for mobile communication, and has been introduced into commercial systems.

However, as a result of sudden increase of mobile communication users in accordance with spread of the mobile communication for late years, there is a problem in that the number of frequencies becomes short due to call requests more than capacity of frequency channels assigned to the mobile communication.

Therefore, the Space Division Multiple Access (SDMA), which realizes the communication with the users in one (single) frequency band, has been proposed so as to realize expansion of the channel capacity by increasing a utilization efficiency of the frequency. In the SDMA, the plural users are separated by difference in space, by turning a main beam orientation of a directivity of a base station antenna toward a desired user and turning a null orientation of the directivity of the base station antenna toward other users.

As a technique for realizing the SDMA, there is a radio communication technique called as MIMO (Multiple Input Multiple Output), in which a data transmission and reception band is broadened by combining plural antennas. In the MIMO, it is necessary to install plural antennas for dividing a transmission data into plural signals (streams) and simultaneously transmitting the divided signals.

Japanese Patent Laid-Open No. 2001-313525 (JP-A 2001-313525) proposes a mobile communication base station antenna for realizing the SDMA, in which plural array antennas are located linearly (on a straight line) or annularly (on a circumference of a circle) so as to improve resolution capability of the plural users.

In addition, K. Nishimori et al, “Channel Capacity Measurement of 8×2 MIMO Transmission by Antenna Configurations in an Actual Cellular Environment”, IEEE TRANSACTIONS ON ANTENNAS AND PROPAGATION, VOL.54, No. 11, November 2006, pp. 3285-3291 proposes a mobile communication base station for realizing the SDMA, in which four array antennas using V-H (vertical and horizontal) polarized wave and ±45 degree slant polarized wave are arranged in a horizontal direction.

However, in the conventional antenna devices proposed by JP-A 2001-313525 and Nishimori et al, there is a problem in that installation occupied area of the mobile communication base station antenna in total is increased since the array antennas are disposed linearly or annularly. In addition, when the array antennas are disposed linearly or annularly, there is another problem in that the installation occupied area of the mobile communication base station antenna is further increased since a large space (interval) between adjacent array antennas is required so as to obtain a space diversity effect.

As described above, there is the problem in that the installation occupied area of the antenna is increased when the MIMO is introduced so as to improve the utilization efficiency of the frequency, since the number of the array antennas should be increased. Further, there is a further problem in that a construction cost is increased when the number of the array antennas is increased, since installation work of respective array antennas and ancillary facilities of the respective array antennas such as cable are required in accordance with the number of the array antennas.

In late years, in accordance with spread of high-speed radio communication including portable telephone, the mobile communication base station antennas overflow all over the town. However, since the mobile communication base station antenna is generally installed on a steel tower or a roof of a high building, the increase in the number of the array antennas raises the cost for installation or damages the landscape, so that it is unfavorable to increase the number of the array antennas.

Therefore, it is indispensable to introduce the MIMO by arranging the plural array antennas so as to increase the channel capacity by improving the utilization efficiency of the frequency. However, since there is a request of avoiding the increase in the installation occupied area as much as possible, the mobile communication base station antenna with a small installation occupied area is strongly desired.

Yoshio Ebine et al “A Study of Vertical Space Diversity for a Land Mobile Radio”, The Institute of Electronics, Information and Communication Engineers (IEICE) Transactions, B-II No. 6, June 1990, pp. 286-292 proposes a technique of reducing the antenna installation occupied area by perpendicularly arranging two reception antennas on a vertical axis to provide a vertical space diversity.

However, Ebine et al merely clarify the effectiveness of the vertical space diversity antenna theoretically and experimentally from the view point of the antenna interval (spacing) and an antenna correlation coefficient, and remain on verification of the space diversity effect thereof. In other words, Ebine et al do not mention about an array antenna structure for realizing the SDMA.

### SUMMARY OF THE INVENTION

Therefore, an object of the present invention is to solve the above problem and to provide a mobile communication base station antenna for realizing the SDMA without largely increasing the installation occupied area of the mobile communication base station antenna compared with that of the conventional device.

According to a feature of the present invention, a mobile communication base station antenna comprises:
two or more array antennas, each of the array antennas comprising a plurality of antenna element pairs arranged in array shape, each of the antenna element pairs comprising two antenna elements located to be orthogonal to each other, polarization characteristics of the two antenna elements being orthogonal to each other,
wherein the array antennas are arranged with a predetermined distance in a vertical direction.

In the mobile communication base station antenna, the predetermined distance may be determined such that an antenna correlation coefficient between the array antennas is 0.8 or less.

In the mobile communication base station antenna, the predetermined distance may be determined such that an antenna correlation coefficient between the array antennas is 0.7 or less.

In the mobile communication base station antenna, the predetermined distance may be within a range of 4 to 10 times of a wavelength of a frequency band to be used for the mobile communication.

In the mobile communication base station antenna, the predetermined distance may be within a range of 5 to 10 times of a wavelength of a frequency band to be used for the mobile communication.

In the mobile communication base station antenna, the array antennas may be connected by a conductive plate provided as a common ground potential for the array antennas.

In the mobile communication base station antenna, one of the two antenna elements may be inclined at an angle of +45 degrees to the vertical direction and another of the two antenna elements may be inclined at an angle of −45 degrees to the vertical direction.

In the mobile communication base station antenna, one of the two antenna elements may vertically arranged and another of the two antenna elements may be horizontally arranged.

In the mobile communication base station antenna, one of the two antenna elements may be vertically arranged and another of the two antenna elements may be horizontally arranged in one of the array antennas, and one of the two antenna elements is inclined at an angle of +45 degrees to the vertical direction and another of the two antenna elements is inclined at an angle of −45 degrees to the vertical direction in another of the array antennas.

In the mobile communication base station antenna, one of the antenna element pairs, in which one of the antenna elements is vertically arranged and another of the two antenna elements is horizontally arranged, and another of the antenna element pairs, in which one of the antenna elements is inclined at an angle of +45 degrees to the vertical direction and another of the antenna elements is inclined at an angle of −45 degrees to the vertical direction, are alternately arranged.

In the mobile communication base station antenna, the antenna element may comprise a half wave dipole antenna.

In the mobile communication base station antenna, the antenna element may comprise a patch antenna.

### (Points of the Invention)

According to the present invention, it is possible to provide a mobile communication base station antenna for realizing the SDMA without largely increasing the installation occupied area of the mobile communication base station compared with the conventional system. It is possible to realize the SDMA in the vertical direction by disposing two or more array antennas in the vertical direction, thereby increasing the data communication capacity by the MIMO. Therefore, it is possible to realize the data communication with a speed higher than that of the conventional system.

### BRIEF DESCRIPTION OF THE DRAWINGS

Next, the mobile communication base station antenna in preferred embodiments according to the invention will be explained in conjunction with appended drawings, wherein:

FIG. 1 is a schematic diagram of the mobile communication base station antenna in a first preferred embodiment according to the invention;

FIGS. 2A and 2B are explanatory diagrams of a structure of the array antenna in the mobile communication base station antenna in the first preferred embodiment according to the invention, wherein FIG. 2A is a front view of the array antenna and FIG. 2B is a side view of the array antenna;

FIG. 3 is an explanatory diagram showing a perspective view of the array antenna in the mobile communication base station antenna in the first preferred embodiment shown in FIG. 2;

FIG. 4 is an explanatory diagram for explaining the antenna element structure by disassembling the array antennas in the mobile communication base station antenna in the first preferred embodiment;

FIGS. 5A and 5B are explanatory diagrams showing an adjustment of the antenna correlation coefficient by changing a distance between the array antennas in the mobile communication base station antenna, in which FIG. 5A shows a case where the antenna correlation coefficient is large and FIG. 5B shows a case where the antenna correlation coefficient is small;

FIG. 6 is a graph showing a relationship between the antenna correlation coefficient between the first array antenna and the second array antenna and a communication capacity in the mobile communication base station antenna;

FIG. 7 is a graph showing an example of relationship between the antenna correlation coefficient and the distance between the first array antenna and the second array antenna in the mobile communication base station antenna when employed in 2 GHz band;

FIG. 8 is a schematic diagram of a mobile communication base station antenna in the second preferred embodiment according to the present invention;

FIG. 9 is a schematic diagram of a mobile communication base station antenna in the third preferred embodiment according to the present invention; and

FIG. 10 is a schematic diagram of a mobile communication base station antenna in the fourth preferred embodiment according to the present invention.

### DETAILED DESCRIPTION OF THE PREFERRED EMBODIMENTS

Next, the preferred embodiments according to the present invention will be explained below in more detail in conjunction with appended drawings.

The mobile communication base station antenna according to the present invention realizes the SDMA and realizes the MIMO, in which the plural antennas are combined to broaden the band for the data transmission and reception.

### First Preferred Embodiment

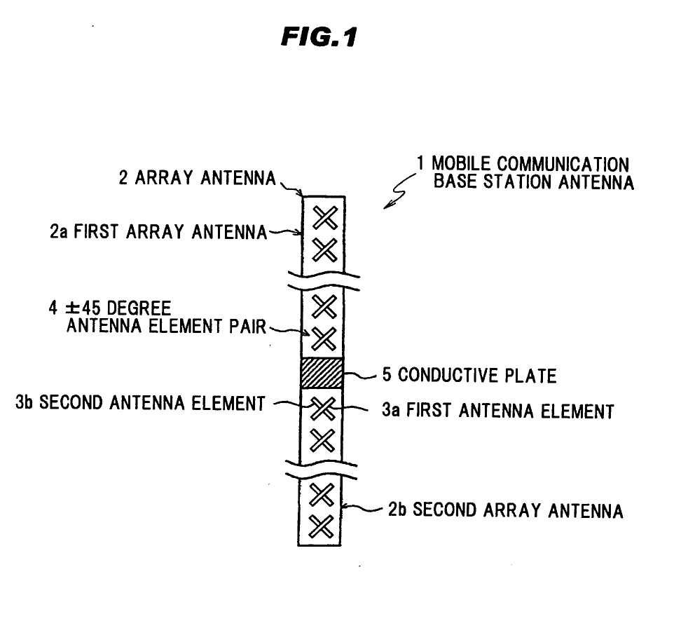

FIG. 1 is a schematic diagram of the mobile communication base station antenna in a first preferred embodiment according to the invention.

As shown in FIG. 1, a mobile communication base station antenna 1 comprises two or more array antennas 2 (two array antennas 2 in FIG. 1), and respective array antennas 2 are arranged in a vertical direction with a predetermined interval (distance). In this preferred embodiment, the mobile communication base station antenna 1, in which a first array antenna 2a and a second array antenna 2b are arranged in the vertical direction, will be explained.

The first and second array antennas 2a, 2b are connected with each other via a conductive plate 5. The conductive plate 5 is provided as a common ground potential (GND potential) for the first and second array antennas 2a, 2b. The first and second array antennas 2a, 2b are located to be separated from each other with a predetermined distance in the vertical direction.

Each of the first and second array antenna 2a, 2b comprises a plurality of antenna element pairs 4 disposed in array shape. The antenna element pair 4 comprises a first antenna element 3a and a second antenna element 3b that are disposed to be orthogonal to each other and polarization characteristics of which are orthogonal to each other.

In other words, the mobile communication base station antenna 1 comprises array antennas 2, each of the array antennas 2 comprises a plurality of the antenna element pairs 4 arranged in array shape, each of the antenna element pairs 4 comprises the two antenna elements 3a, 3b located to be orthogonal to each other, and polarization characteristics of the two antenna elements 3a, 3b are orthogonal to each other, in which the number of the array antennas are two or more and the array antennas arranged with the predetermined distance in the vertical direction, so as to improve the frequency utilization efficiency, thereby increasing a channel capacity.

In this preferred embodiment, the antenna element pair 4 is a ±45 degree antenna element pair 4, in which a first antenna element 3a is inclined at an angle of +45 degrees with respect to the vertical direction and a second antenna element 3b is inclined at an angle of −45 degrees with respect to the vertical direction. In other words, the array antenna 2 used in the first preferred embodiment is a dual-polarized antenna, in which +45 degree polarized wave and −45 degree polarized wave are dually used in one antenna.

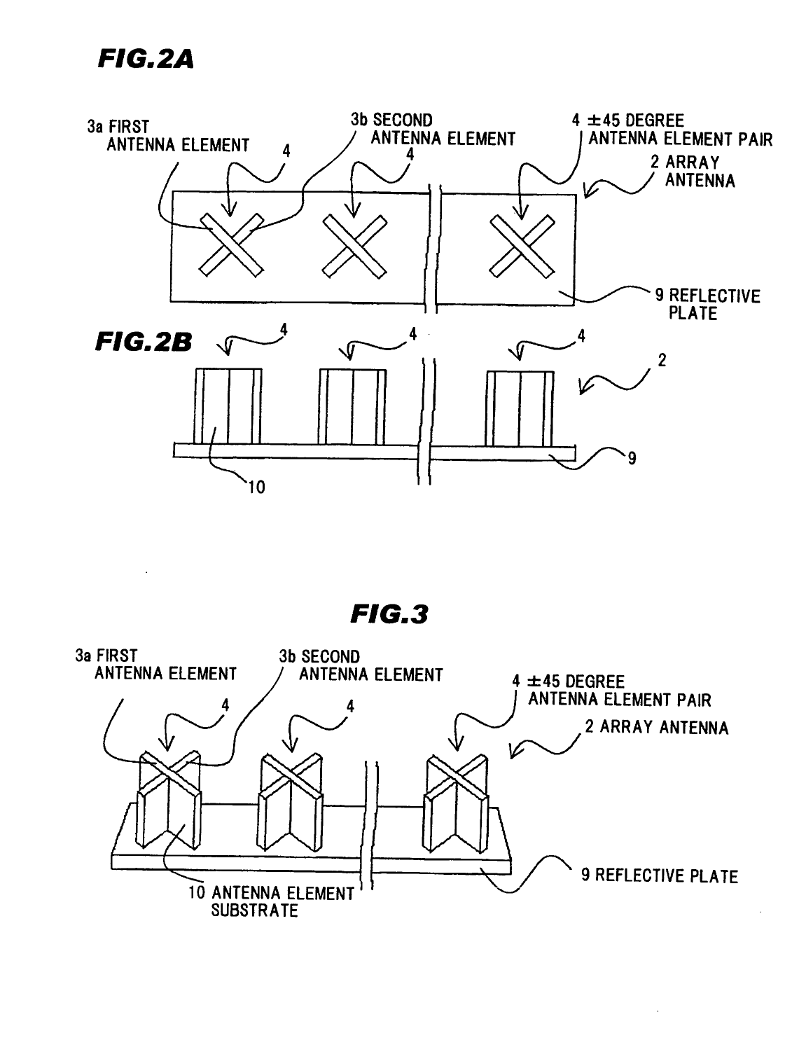

FIGS. 2A and 2B are explanatory diagrams of a structure of the array antenna 2 in the first preferred embodiment (i.e. the dual-polarized antenna is used as the array antenna 2), wherein FIG. 2A is a front view of the array antenna 2 and FIG. 2B is a side view of the array antenna 2.

FIG. 3 is a perspective view of the array antenna 2 shown in FIG. 2.

As shown in FIGS. 2A-2B and FIG. 3, the array antenna 2 has a structure in which antenna element pairs (±45 degree antenna element pairs) 4 are disposed in the array shape along a longitudinal direction of a reflective plate 9. The antenna element pairs (±45 degree antenna element pairs) 4 are construed by combining the first and second antenna elements 3a, 3b to have a cross-shaped in its cross sectional view. Each of the first and second antenna elements 3a, 3b is construed by forming an antenna element pattern comprising a metal, a combination of the metal and a dielectric material, or the like on a surface of an antenna element substrate 10. It is possible to transmit and receive electric waves as +45 degree polarized wave and −45 degree polarized wave in dual mode. The first antenna element 3a and the second antenna elements 3b are respectively connected to different feeding points (not shown) via feeding lines.

Further, in this preferred embodiment, a half wave dipole antenna is used as the first and second antenna elements 3a, 3b. In addition, half wave dipole antennas disclosed by Japanese Patent Laid-Open No.2004-32392 (JP-A 2004-32392) and Japanese Patent Laid-Open No. 2004-266600 (JP-A 2004-266600) may be used as the half wave dipole antenna in this preferred embodiment. However, the first and second antenna elements 3a, 3b are not limited to the half wave dipole antenna, and a patch antenna and other polarized wave diversity antenna elements may be used.

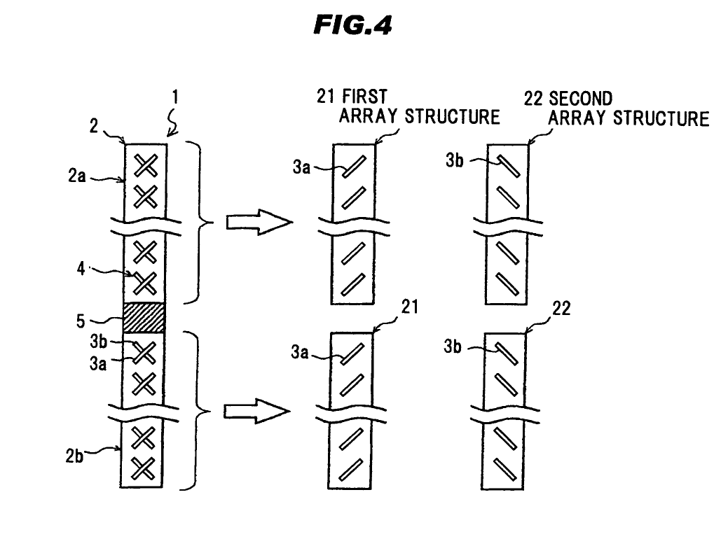

FIG. 4 is an explanatory diagram for explaining the antenna element structure by disassembling the first and second array antennas 2a, 2b.

As shown in FIG. 4, each of the first and second array antennas 2a, 2b comprises a first array structure 21 comprising the first antenna elements 3a arranged in the array shape, each of the first antenna elements 3a being inclined at angle of +45 degrees, and a second array structure 22 comprising the second antenna elements 3b arranged in the array shape, each of the second antenna elements 3b being inclined at angle of −45 degrees. The first array structure 21 and the second array structure 22 are superimposed on the same location to form the ±45 degree antenna element pairs) 4 as elements of the polarized wave diversity antenna, thereby providing the first and second array antennas 2a, 2b.

Dimensions of each of the first and second antenna elements 3a, 3b may be appropriately determined in accordance with the frequency and the bandwidth to be used. In addition, the number of the antenna element pairs 4 may be appropriately determined in accordance with a desired antenna specification such as antenna transmission gain or beam width of the antenna.

Since the first and second array antennas 2a, 2b composes a ±45 degree slant diversity antenna, an antenna correlation coefficient between the first array structure 21 and the second array structure 22 ideally approximates zero (0). Therefore, it is possible to obtain the same effect as providing two slant diversity antennas of an ordinary type, by using one of the first and second array antennas 2a, 2b as a dual-polarized antenna. Therefore, it is possible to realize 2MIMO antenna structure by a single array antenna.

Therefore, it is possible to provide the mobile communication base station antenna 1 of 4MIMO (or 4-diversity) in total by using two array antennas (the first and second array antennas 2a, 2b).

When the plural array antennas 2 are used, there is a problem of the antenna correlation coefficient between the two respective array antennas 2 (i.e. between the first array antenna 2a and the second array antenna 2b). If the antenna correlation coefficient is large, a correlation between signals received at the first and second array antennas 2a, 2b will be increased. As a result, it is not possible to provide a sufficient enhancement in the communication capacity.

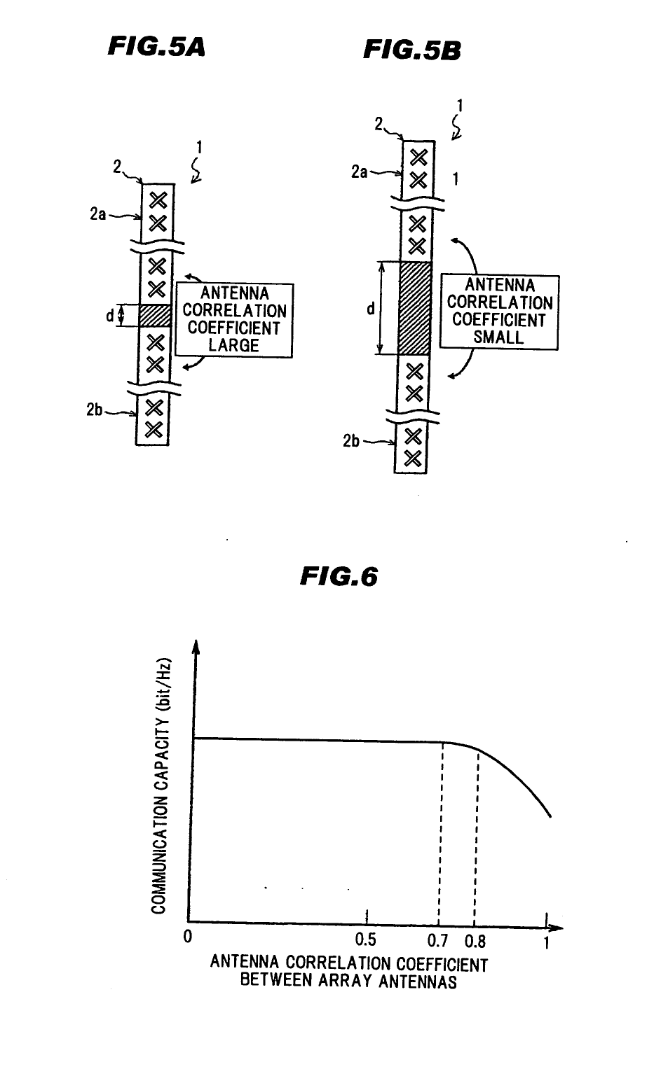

FIGS. 5A and 5B are explanatory diagrams showing an adjustment of the antenna correlation coefficient by changing a distance between the array antennas 2 in the mobile communication base station antenna 1, in which FIG. 5A shows a case where the antenna correlation coefficient is large and FIG. 5B shows a case where the antenna correlation coefficient is small.

As shown in FIGS. 5A and 5B, the antenna correlation coefficient can be adjusted by changing a distance (location interval) d in the vertical direction between the first array antenna 2a and the second array antenna 2b. In other words, the antenna correlation coefficient can be adjusted by changing the distance d between adjacent array antennas 2 in the vertical direction.

As shown in FIG. 5A, when the distance d between the first array antenna 2a and the second array antenna 2b is small, the antenna correlation coefficient is unfavorably increased. Therefore, it is necessary to increase the distance d between the first array antenna 2a and the second array antenna 2b, so as to decrease the antenna correlation coefficient. However, as shown in FIG. 5B, when the distance d between the first array antenna 2a and the second array antenna 2b is large, an entire length (a dimension in the vertical direction) of the mobile communication base station antenna 1 is increased. Therefore, it is necessary to determine an optimum value of the distance d between the first array antenna 2a and the second array antenna 2b.

FIG. 6 is a graph showing a relationship between the antenna correlation coefficient between the first array antenna 2a and the second array antenna 2b and a communication capacity in the mobile communication base station antenna 1.

As shown in FIG. 6, when the antenna correlation coefficient is from 0 to 0.8, more preferably from 0 to 0.7, the communication capacity is almost constant in the mobile communication base station antenna 1. In the above ranges, the communication capacity is influenced by actual radio transmission conditions, so that the effect of enhancing the communication capacity is not large regardless the decrease in the antenna correlation coefficient between the first array antenna 2a and the second array antenna 2b. Therefore, it is sufficient to provide the antenna correlation coefficient to be 0.8 or less, preferably 0.7 or less.

Therefore, in this preferred embodiment, the distance d between the first array antenna 2a and the second array antenna 2b is adjusted in such a manner that the antenna correlation coefficient is 0.8 or less, preferably 0.7 or less. The distance d between the first array antenna 2a and the second array antenna 2b may be adjusted by adjusting an entire length the conductive plate 5 in the vertical direction. In other words, the entire length of the conductive plate 5 in the vertical direction may be determined as the length equal to the distance d by which the antenna correlation coefficient is 0.8 or less, and the first array antenna 2a and the second array antenna 2b may be connected with the conductive plate 5 with the entire length thus determined.

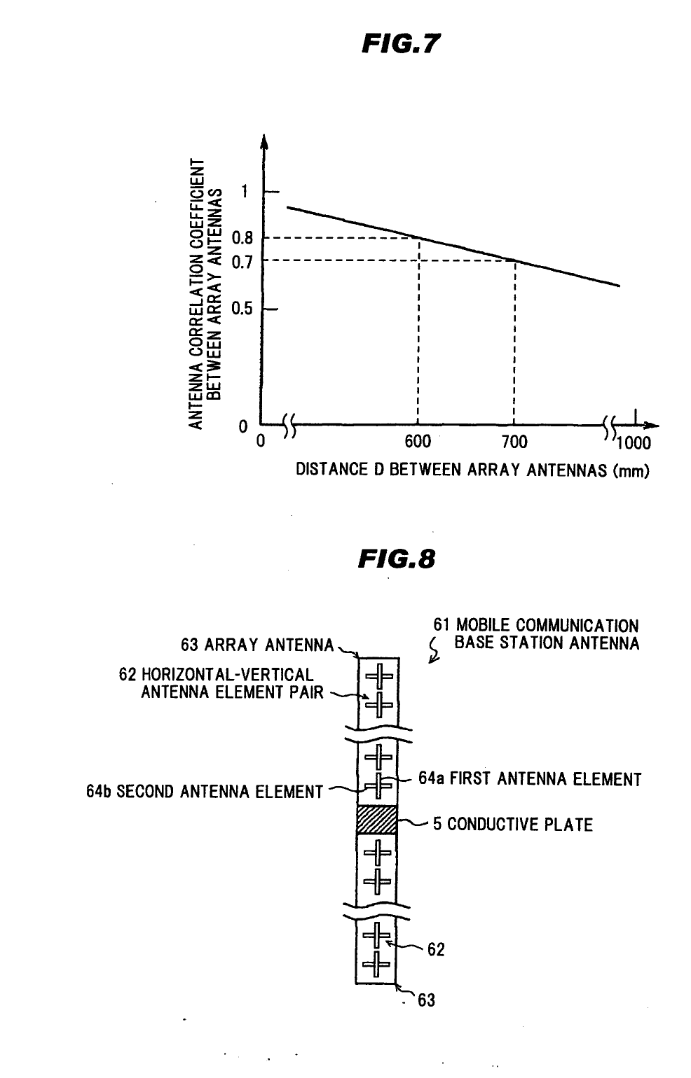

FIG. 7 is a graph showing an example of relationship between the antenna correlation coefficient and the distance d between the first array antenna 2a and the second array antenna 2b in the mobile communication base station antenna 1 when employed in 2 GHz band.

As shown in FIG. 7, when the mobile communication base station antenna 1 is used in the 2 GHz band, the distance d between the first array antenna 2a and the second array antenna 2b is required to be about 600 mm, so as to realize the antenna correlation coefficient therebetween of 0.8. Preferably, the distance d between the first array antenna 2a and the second array antenna 2b is required to be about 700 mm, so as to realize the antenna correlation coefficient therebetween of 0.7.

In this preferred embodiment, the case where the mobile communication base station antenna 1 is used in 2 GHz band is explained. In general, a frequency used in the 2 GHz band for the mobile communication is from about 1920 MHz to about 2200 MHz, and a wavelength thereof is around 150 mm, more precisely from about 156 mm to about 136 mm.

In order to realize the antenna correlation coefficient of 0.7 or less, it is sufficient to determine the distance (location interval) d between the first array antenna 2a an the second array antenna 2b in the vertical direction within a range of 700 mm or more. In order to realize the antenna correlation coefficient of 0.8 or less, it is sufficient to determine the distance (location interval) d between the first array antenna 2a an the second array antenna 2b in the vertical direction within a range of 600 mm or more. Therefore, a lower limit of the distance d is 600 mm, which corresponds to four (4) wavelength (i.e. four times of the wavelength of the used frequency). Preferably, the lower limit of the distance d is 700 mm, which corresponds to five (5) wavelength (i.e. five times of the wavelength of the used frequency).

On the other hand, as described above, the entire length of the mobile communication base station antenna 1 is also increased in accordance with the increase in the distance d. Although the entire length of the mobile communication base station antenna 1 may be appropriately determined, it is preferable to determine an upper limit of the distance d as 1500 mm, which corresponds to ten (10) wavelength (i.e. ten times of the wavelength of the used frequency). If the distance d is greater than this upper limit i.e. ten wavelength, the installation cost of the mobile communication base station antenna 1 will be unfavorably increased. For example, when the mobile communication base station antenna 1 is installed on a roof of the architectural structure such as building, the mobile communication base station antenna 1 with the distance d greater than the upper limit cannot be transferred by using an elevator equipped in the architectural structure, so that the mobile communication base station antenna 1 should be transferred by additionally using a large crane and other heavy equipments.

In this preferred embodiment, the case where the two array antennas 2 (the first and second array antennas 2a, 2b) are used is explained. However, the present invention is not limited thereto. It will be sufficient if the number of the array antennas 2 is two or more. When the number of the array antennas 2 is N, it is possible to realize a 2×N MIMO antenna by arranging the respective array antennas 2 with a predetermined interval d.

Next, functions of the mobile communication base station antenna 1 in this preferred embodiment will be explained below.

In the mobile communication base station antenna 1 in this preferred embodiment, the two or more array antennas 2 are provided, each of the array antenna comprises the antenna element pairs 4 arranged in the array shape, each of the antenna element pairs 4 comprises two antenna elements 3a, 3b having the polarization characteristics orthogonal to each other, and the array antennas 2 are arranged with the predetermined distance d in the vertical direction.

It is possible to realize the SDMA in the vertical direction without largely increasing the installation occupied area by arranging the two or more array antennas 2 in the vertical direction. Therefore, it is possible to increase the data communication capacity by MIMO, thereby realizing the high-speed data communication compared with the conventional system.

Further, it is not necessary to install an extra antenna (array antenna), since the two or more array antennas 2 are arranged in the vertical direction to provide the mobile communication base station antenna 1. Therefore, addition of mechanical installation mechanism such as pole brace for exclusive use in antenna installation or installation metal fitting is minimized or no longer necessary.

Still further, since the dual-polarized antenna is used as the array antenna 2 in this preferred embodiment, it is possible to realize the MIMO antenna with the number of 2×N (N is the number of the array antennas 2). Therefore, it is possible to realize numerous MIMO antennas without largely increasing the installation occupied area.

Finally, in this preferred embodiment, the distance (location interval) d between the adjacent array antennas 2 is determined such that the antenna correlation coefficient between the adjacent array antenna is 0.8 or less. In this preferred embodiment, the two or more array antennas 2 are arranged in the vertical direction, the entire length of the mobile communication base station antenna 1 in the vertical direction is increased. However, it is possible to minimize the dimension of the mobile communication base station antenna 1 in the vertical direction and to obtain a sufficient communication capacity, by determining the distance d in such a manner that the antenna correlation coefficient between the adjacent array antennas 2 is 0.8 or less. The upper limit of the distance d is ten times of the wavelength of the used frequency.

### Second Preferred Embodiment

Next, a mobile communication base station antenna 61 in a second preferred embodiment will be explained below.

FIG. 8 is a schematic diagram of the mobile communication base station antenna 61 in the second preferred embodiment according to the present invention. In the second preferred embodiment, the array antenna 2 in which the ±45 degree antenna element pairs 4 are arranged in the array shape in the mobile communication base station antenna 1 shown in FIG. 1 is replaced with an array antenna 63 in which horizontal-vertical antenna element pairs 62 are arranged in array shape. In the horizontal-vertical antenna element pair 62, a first antenna element (vertical antenna element) 64a is located vertically and a second antenna element (horizontal antenna element) 64b is located horizontally.

In the mobile communication base station antenna 61, the ±45 degree antenna element pairs 4 are replaced with the horizontal-vertical antenna element pairs 62. Therefore, it is possible to provide the same effect as that of the mobile communication base station antenna 1 in FIG. 1.

### Third Preferred Embodiment

Next, a mobile communication base station antenna 71 in a third preferred embodiment will be explained below.

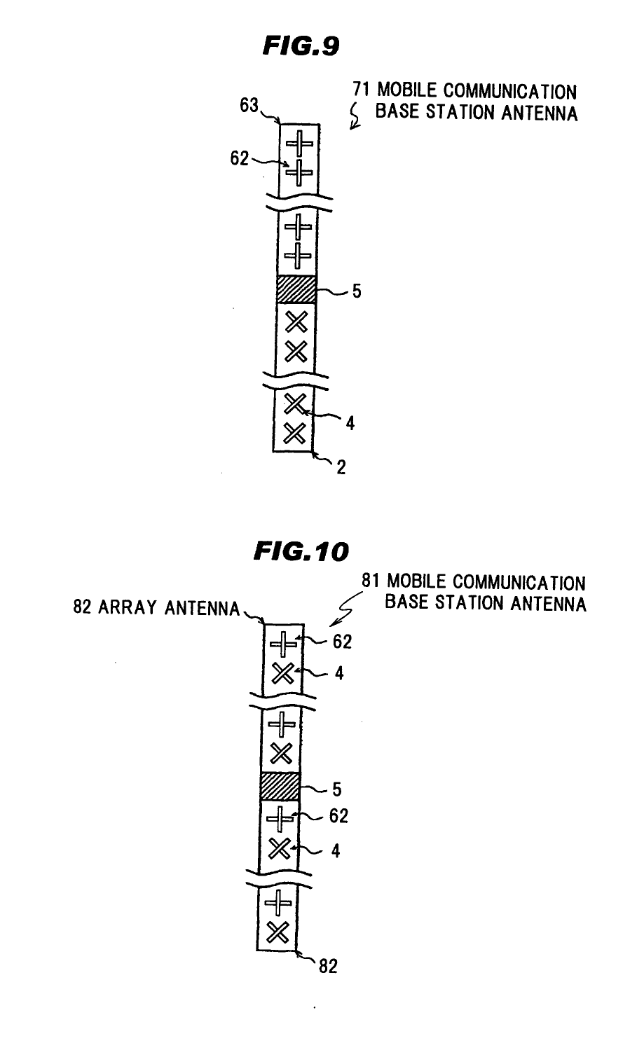

FIG. 9 is a schematic diagram of the mobile communication base station antenna 71 in the third preferred embodiment according to the present invention.

In the mobile communication base station antenna 71 as shown in FIG. 9, the array antenna 2 in which the ±45 degree antenna element pairs 4 are arranged in the array shape and the array antenna 63 in which the horizontal-vertical antenna element pairs 62 are arranged in the array shape are arranged in the vertical direction.

Since a polarization direction of the array antenna 2 is different from that of the array antenna 63, it is possible to reduce the antenna correlation coefficient between the array antenna 2 and the array antenna 63 by arranging the array antenna 2 and the array antenna 63 to be adjacent to each other, compared with the first preferred embodiment in which the array antennas 2 are adjacent to each other and the third preferred embodiment in which the array antennas 63 are adjacent to each other. Therefore, it is possible to reduce the distance d between the array antenna 2 ad the array antenna 63, thereby reducing the dimension of the mobile communication base station antenna 71 in the vertical direction.

Although FIG. 9 shows one example of using one array antenna 2 and one array antenna 63, the present invention is not limited thereto. The number of the array antennas 2 may be different from the number of the array antennas 63. Further, it is not necessary to locate the array antenna 2 and the array antenna 63 to be adjacent to each other. Even in this case, the effect is same as the effect of the mobile communication base station antenna 1 in the first preferred embodiment shown in FIG. 1.

### Fourth Preferred Embodiment

Next, a mobile communication base station antenna 81 in a fourth preferred embodiment will be explained below.

FIG. 10 is a schematic diagram of the mobile communication base station antenna 81 in the fourth preferred embodiment according to the present invention.

In the mobile communication base station antenna 81 as shown in FIG. 10, an array antenna 82 in which the ±45 degree antenna element pair 4 and the horizontal-vertical antenna element pairs 62 are arranged alternately, and two array antennas 82 are arranged in the vertical direction.

The mobile communication base station antenna 81 as shown in FIG. 10 provides the effect same as that of the mobile communication base station antenna 1 in the first preferred embodiment shown in FIG. 1.

Although the invention has been described, the invention according to claims is not to be limited by the above-mentioned embodiments and examples. Further, please note that not all combinations of the features described in the embodiments and the examples are not necessary to solve the problem of the invention.

What is claimed is:

1. A mobile communication base station antenna comprising:
two or more array antennas, each of the array antennas comprising a plurality of antenna element pairs arranged in array shape, each of the antenna element pairs comprising two antenna elements located to be orthogonal to each other, polarization characteristics of the two antenna elements being orthogonal to each other,
wherein the array antennas are arranged with a predetermined distance in a vertical direction.

2. The mobile communication base station antenna according to claim 1, wherein the predetermined distance is determined such that an antenna correlation coefficient between the array antennas is 0.8 or less.

3. The mobile communication base station antenna according to claim 1, wherein the predetermined distance is determined such that an antenna correlation coefficient between the array antennas is 0.7 or less.

4. The mobile communication base station antenna according to claim 1, wherein the predetermined distance is within a range of 4 to 10 times of a wavelength of a frequency band to be used for the mobile communication.

5. The mobile communication base station antenna according to claim 1, wherein the predetermined distance is within a range of 5 to 10 times of a wavelength of a frequency band to be used for the mobile communication.

6. The mobile communication base station antenna according to claim 1, wherein the array antennas are connected by a conductive plate provided as a common ground potential for the array antennas.

7. The mobile communication base station antenna according to claim 1, wherein one of the two antenna elements is inclined at an angle of +45 degrees to the vertical direction and another of the two antenna elements is inclined at an angle of −45 degrees to the vertical direction.

8. The mobile communication base station antenna according to claim 1, wherein one of the two antenna elements is vertically arranged and another of the two antenna elements is horizontally arranged.

9. The mobile communication base station antenna according to claim 1, wherein one of the two antenna elements is vertically arranged and another of the two antenna elements is horizontally arranged in one of the array antennas, and one of the two antenna elements is inclined at an angle of +45 degrees to the vertical direction and another of the two antenna elements is inclined at an angle of −45 degrees to the vertical direction in another of the array antennas.

10. The mobile communication base station antenna according to claim 1, wherein one of the antenna element pairs, in which one of the antenna elements is vertically arranged and another of the two antenna elements is horizontally arranged, and another of the antenna element pairs, in which one of the antenna elements is inclined at an angle of +45 degrees to the vertical direction and another of the antenna elements is inclined at an angle of −45 degrees to the vertical direction, are alternately arranged.

11. The mobile communication base station antenna according to claim 1, wherein the antenna element comprises a half wave dipole antenna.

12. The mobile communication base station antenna according to claim 1, wherein the antenna element comprises a patch antenna.
